(19) United States
(12) Patent Application Publication
(10) Pub. No.: US 2016/0184787 A1
(43) Pub. Date: Jun. 30, 2016

(54) Surface-Modified Metal Colloids and Production Thereof

(71) Applicant: LEIBNIZ-INSTITUT FÜR NEUE MATERIALIEN GEMEINNÜTZIGE GMBH, Saarbrücken (DE)

(72) Inventors: Carsten Becker-Willinger, Saarbruecken (DE); Mirko Bukowski, St. Ingbert (DE); Budiman Ali, Saarbruecken (DE); Marlon Jochum, Marpingen (DE)

(21) Appl. No.: 14/909,474

(22) PCT Filed: Aug. 7, 2014
(86) PCT No.: PCT/EP2014/066997

§ 371 Date: Feb. 2, 2016

(30) Foreign Application Priority Data
Aug. 9, 2013 (DE) 10 2013 108 664.0

(51) Int. Cl. B01J 13/00

(52) U.S. Cl. CPC B01J 13/0043

(57) ABSTRACT

Metal colloids are surface-modified with low-molecular-weight compounds. In order to produce the metal colloids, metal ions are reduced in the presence of surface modifiers and then purified. The method is also suitable for the surface modification of metal colloids.

### FIELD OF THE INVENTION

The present invention relates to surface-modified metal colloid particles which can be dispersed equally both in water and in less polar as well as nonpolar organic media. They are therefore suitable for use in a very wide variety of matrix environments, such as, for example, in solvent-free, water-based paints, as well as high-solid systems and permit a direct use in surface coatings without complex work-up of intermediates that usually arise during the formulation of the same. On account of their composition, the metal colloid particles can be used as additives for establishing electric, photonic, optical and also in particular physiologically effective properties.

### PRIOR ART

Metal colloid particles are usually obtained by reduction processes from ionic precursors, mostly metal salts. The reduction reaction can be induced either thermally or photochemically in the presence of a reducing agent. In order to ensure the colloidochemical stability of the formed dispersions, a very wide variety of dispersion auxiliaries are generally used.

DE 102006017696 A1 relates to a process for producing concentrated metal particle soles with a metal particle content ≧1 g/l in a two-stage synthesis step. Here, a metal salt solution is reacted firstly with a solution containing hydroxide ions and then, in a second step, with a reducing agent, where at least one of the solutions comprises an obligatory dispersion auxiliary (protective colloid). The dispersion auxiliaries are organic low molecular weight and polymeric compounds with hydroxyl, amino, amido or sulphonate groups as functional groups. The hydroxide ions originate from typical bases, such as e.g. alkali metal hydroxides, aliphatic amines or alkali metal alkoxides. Reducing agents are e.g. ascorbic acid, hydrazine or sodium borohydride.

A similar approach via the formation of micelles from a block copolymer which comprise the colloidal metal in incorporated form is pursued in DE 19506113 A1.

A disadvantage of both approaches is firstly the use of a toxic reducing agent (hydrazine, sodium borohydride), which must be used in excess in order to achieve a complete reduction of the ionic precursor to the metal. This is an important point particularly if they are relatively reactive metals, such as e.g. copper, which can easily be prematurely oxidized again by atmospheric oxygen. The residual amount of toxic reducing agent present after the reaction must be completely removed, possibly in a complex process. Following the complete removal of the residual amount of reducing agent, the resulting particles are no longer protected against subsequent, mostly uncontrolled oxidation, which considerably reduces the long-term stability in the sense of the metal colloid character. Furthermore, the use of specifically selected dispersion auxiliaries is disadvantageous since a change in the target media renders necessary a targeted adaptation of the dispersion auxiliary used and these molecules likewise offer no protection against subsequent oxidation for metal colloids of reactive metals. This is likewise a disadvantage of the work of EP 0796147 B1 in which surfactant-stabilized, reversible mono- and bimetal colloids are formed from metal salts in the presence of strongly hydrophilic surfactants with chemical reducing agents. In this case, the usability of the particles is limited for example exclusively to water as dispersion medium. The same is also true for U.S. Pat. No. 8,071,259 B2, where pure precious metal colloids and colloids are precious metals in combination with more reactive metals in aqueous solution with a polysaccharide as temporary stabilizer are disclosed for producing a catalytically effective coating on a polymer electrolyte membrane.

For applications in the medical diagnostic sector, metal sol particles are often required which have the narrowest possible particle size distribution within a selected particle size range.

One process for producing such particles is claimed in EP 0426300 B1. The multistage synthesis process itself starting from a solution containing first metal, stabilizing agent and a first reducing agent and subsequent mixing of the formed metallic nuclei with a further solution of metal and a second reducing agent very readily reveals the high expenditure of the overall process. The second reducing agent here serves to prevent the spontaneous enucleation of the formed particles. Semiconductor and metal colloids can be provided during the synthesis also with bifunctional ligands, such as e.g. functional alkylalkoxysilanes.

EP 1034234 B1 also uses this route in order to subsequently equip the formed colloid particles with inert oxidic protective sheaths made of e.g. SiO₂, Al₂O₃ or ZrO₂. The modifications from the precursor formed beforehand, however, cannot be dispersed in any desired media and the oxidic protective sheaths furthermore hermetically shield the core.

The already mentioned ascorbic acid was also used as reducing agent by [Xuedong Wu et al., Green Chem. 2011, 13, 900] in order to produce oxidation-stable copper colloids from copper salts which can be used for producing conductive inks (CN 101880493 A). The ascorbic acid here is partially oxidized to dehydroascorbic acid in the course of the reduction reaction and remains on the surface of the formed copper colloid particles. A disadvantage here is that the majority of ascorbic acid used is not converted and remains on the surface of the particles formed. Although this is positive in terms of a lasting prevention of a subsequent oxidation process in the sense of retaining long-term stability, it is disadvantageous in connection with a desirable physiological effect such as e.g. a microbicidal effectiveness, which requires for example a controlled release of copper ions through selective, on-demand oxidation under physiologically relevant conditions.

### Problem

The problem addressed by the present invention is to indicate a process which permits a simple production of metal colloid particles without additional protective colloid. The metal colloid particles produced are stabilized against uncontrolled oxidation and are therefore suitable in a simple manner for electric, optical, optoelectronic, photonic and in particular physiologically relevant, e.g. microbicidal, applications and coatings.

### Solution

This problem is solved by the invention having the features of the independent claims. Advantageous developments of the inventions are characterized in the dependent claims. The wording of all of the claims is hereby incorporated by reference into this description. The inventions also include all meaningful and in particular all mentioned combinations of independent and/or dependent claims.

The problem is solved by a process for producing metal colloids comprising the following steps:

a) production of a composition comprising
a1) at least one type of metal ion;
a2) at least one organic reducing agent;
a3) at least one complexing agent comprising at least one functional group which can interact with the produced metal colloids, the reducing agent and/or the oxidized form of the reducing agent can act as a complexing agent;
a4) at least one solvent;
   b) thermal and/or photochemical activation during or after the production of the composition;
   c) reduction of the at least one type of metal ions to metal colloids;
   d) purification of the modified metal colloids.

Individual process steps are described in more detail below. The steps do not necessarily have to be carried out in the stated order, and the process to be described can also have further unspecified steps.

In a first step, a composition comprising metal ions is produced. The metal ions can be introduced into the composition in various ways. Preference is given to metal salts. These may be nitrates, sulphates, carbonates, halides (fluorides, chlorides, bromides, iodides), metal acids (such as H(AuCl₄), perchlorates), salts of organic acids such as acetates, tartrates, salts of organic anions such as acetylacetonates. Preference is given to chlorides, sulphates, nitrates, metal acids.

The metal ions are preferably ions of the metals of groups 8 to 16. Particular preference is given to ions of the metals Cu, Ag, Au, Ni, Pd, Pt, Co, Rh, Ir, Ru, Os, Se, Te, Cd, Bi, In, Ga, As, Ti, V, W, Mo, Sn and/or Zn, very particularly preferably Cu, Ag, Au, Ni, Pd, Pt, Co, Rh, Ir, Ru, Os, Se, Te and/or Zn.

Examples of possible compounds are CuCl, CuCl₂, CuSO₄, Cu(NO₃)₂, AgNO₃, H(AuCl₄), PdCl₂, ZnCl₂, ZnSO₄, Cu(CH₃COO)₂, copper acetylacetonate, CuCO₃, Cu(ClO₄)₂, where hydrates of these compounds can also be used.

Very particularly preferably, the metal ions are copper ions, in particular copper(II)ions. These can be introduced from the metal salts CuCl₂, CuSO₄, Cu(NO₃)₂, Cu(CH₃COO)₂, copper acetylacetonate, CuCO₃, Cu(ClO₄)₂.

The metal salts can be present in the composition in dissolved form or as part of a suspended solid.

The composition also comprises an organic reducing agent. This must have a sufficiently low redox potential in order to be able to reduce the metal ions of the composition to the metal. In particular, a lower standard potential than the metal of the metal ion that is to be reduced. Thus, copper has a standard potential of 0.337 V (Cu²⁺/Cu⁰), silver has a standard potential of 0.799 V, platinum has a standard potential of 1.2 V and gold has a standard potential of 1.40 V.

In one embodiment of the invention, the organic reducing agent is a low molecular weight compound with a molecular weight of less than 1000 g/mol, less than 800 g/mol, less than 600 g/mol, less than 500 g/mol, less than 400 g/mol. Independently of this, the reducing agents preferably have a molecular weight of more than 30 g/mol, more than 40 g/mol, more than 50 g/mol, more than 60 g/mol, more than 70 g/mol, more than 80 g/mol.

The reducing agents are preferably reductive carboxylic acids, such as oxalic acid, citric acid, tartaric acid, malic acid, sugars, in particular monosaccharides or disaccharides (such as glucose or sucrose), uronic acids, aldehydes, formic acid. Particular preference is given to ascorbic acid, citric acid or malic acid.

The reducing agent is not a polymer or oligomer, i.e. it contains not more than 2 repetitive units.

The reducing agent is soluble or dispersible in the composition.

In one embodiment of the invention, the ratio of reducing agent and metal ions is 5:1 to 1:30, preferably 2:1 to 1:30, calculated as the molar amount of electrons which can be made available by the reducing agent, and the molar amount of electrons which are required for the reduction of all metal ions to the metal. A ratio of 2:1 means that the reducing agent is used in the amount such that twice the molar amount of electrons from the reducing agent can be made available than are required for the reduction of all metal ions. Thus, the reducing agent can provide an excess of electrons. In this case, following reduction of all of the metal ions, a remainder of unreduced reducing agent remains. On the other hand, there is also the option that a deficit of reducing agent with regard to the electrons is used (e.g. 1:2). In this case, unreduced metal ions will remain in the reaction medium. The ratio is preferably 5:1 to 1:5, 3:1 to 1:3, particularly preferably 2:1 to 1:2.

In a preferred embodiment, a deficit of reducing agent is used, i.e. a ratio of less than 1:1, preferably between 1:1 and 1:4, particularly preferably between 1:1 and 1:3. This prevents a nonoxidized reducing agent remaining in the composition and/or on the produced metal colloids. This facilitates the use of these metal colloids for example in biocidal applications where metal ions are to be released into the surrounding area in a controlled manner. Preferred metal colloids for such applications are silver or copper colloids, particularly preferably copper colloids.

The composition also comprises at least one complexing agent. This is a compound which comprises at least one functional group which can interact with the produced metal colloids. One such complexing agent is a compound which forms a complex with the reduced metal colloids. As a result of this, a layer of the complexing agent forms on the surface of the metal colloids in order to protect said colloids from further oxidation. The produced metal colloids are therefore storage-stable and can also be redispersed again after drying without forming agglomerates. At the same time, the complexing agent also influences, as a result of the coating of the surface of the metal colloids, the behaviour of the metal colloids towards their environment. Depending on the complexing agent used, the produced metal colloids can be adapted to different conditions. In this way, it is possible to provide metal colloids which can be redispersed in a large number of media.

A group which can interact with the reduced metal ions is mostly a group with at least one atom with a free electron pair. Preferably, the complexing agent comprises at least one heteroatom selected from the group comprising N, O, S, Cl, Br and I.

Preferably, at least one functional group is selected from the group comprising amino groups, carbonyl groups such as carboxylic acid groups, carboxamide groups, imide groups, carboxylic anhydride groups, carboxylic acid ester groups, aldehyde groups, keto groups, urethanes, carbonyl groups adjacent in 1,2 position or 1,3 position, thiol groups, disulphide groups, hydroxyl groups, sulphonyl groups, phosphoric acid groups. It is also possible for two or more of the aforementioned groups to be present.

Depending on the metal colloid produced, a different functional group may be best suited. Thus, for copper, carbonyl groups or thiols are preferred. For silver colloids, amino functions are preferred.

The complexing agent here is preferably a compound of the formula (I)

Z—R¹

where Z is NH₂, NHR², N(R²)₂, R²—C═O, SH, R²—S—S, R²—(C═O)—(C═O), OH, SO₃, or R²—S═O, and

R¹ is a straight-chain alkyl- or alkoxy group having 4 to 15 carbon atoms or a branched or cyclic alkyl or alkoxy group having 3 to 15 carbon atoms or an alkenyl or alkynyl group having 2 to 15 carbon atoms, where the aforementioned groups can be substituted with in each case one or more radicals R² and where one or more adjacent or nonadjacent CH₂ groups in the aforementioned groups can be replaced by —R²C═CR²—, —C≡C—, C═O, C═NR², —C(═O)—O—, —C(═O)—NR²—, Si(R²)₂, NR², P(═O)(R²), —O—, —S—, SO or SO₂, or an aromatic ring system having 6 to 12 aromatic ring atoms which can be substituted in each case by one or more radical(s) R², or a heteroaromatic ring system having 5 to 12 aromatic ring atoms which can be substituted in each case with one or more radical(s) R².

Here, for each occurrence, R² is identical or different and is H, D, F, Cl, Br, I, OH, CHO, C(═O)R³, CN, CR³═(R³)₂, C(═O)OR³, NCO, OCN, C(═O)N(R³)₂, Si(R³)₃, N(R³)₂, NO₂, P(═O)(R³)₂, OSO₂R³, S(═O)R³, S(═O)₂R³, a straight-chain alkyl, alkoxy, thioalkoxy group having 1 to 15 carbon atoms or a branched or cyclic alkyl, alkoxy, thioalkoxy group having 3 to 15 carbon atoms or an alkenyl or alkynyl group having 2 to 15 carbon atoms, where the aforementioned groups can be substituted in each case with one or more radicals R³ and where one or more adjacent or nonadjacent CH₂ groups in the aforementioned groups can be replaced by —R³C═CR³—, —C≡C—, C═O, C═NR³, —C(═O)—O—, —C(═O)—NR³—, Si(R³)₂, NR³, P(═O)(R³), —O—, —S—, SO or SO₂, or an aromatic ring system having 6 to 30 aromatic ring atoms which can be substituted in each case with one or more radical(s) R³, or a heteroaromatic ring system having 5 to 30 ring atoms which can be substituted in each case with one or more radical(s) R³, where two or more radicals R³ or R¹ and R³ can be linked with one another and can form a ring.

For each occurrence, R³ is identical or different and is H, D, F or an aliphatic, aromatic and/or heteroaromatic radical having 1 to 10 carbon atoms in which one or more H atoms can also be replaced by D or F; here, two or more substituents R⁴ can also be linked with one another and form a mono- or polycyclic, aliphatic, heteroaliphatic, aromatic or heteroaromatic ring system.

Preferred complexing agents have in R¹ at least one functional group having at least one heteroatom.

Preferred complexing agents are dehydroascorbic acid, acetoacetate, acetylacetone, dimethylglyoxal (2-oxopropanal), triketoindane, thiolacetic acid, □, □ or □-amino acids with at least one further functional group for interaction with the metal colloids, such as cystein, cystine, methionine, ornithine, lysine, arginine, histidine, glutamic acid, aspartic acid, asparagine, serine, glycine, glutamine, threonine, tyrosine, tryptophan, 4-mercapto-4-methylpentatone, phosphate, silanes of formula II

SIR⁵ₐX₍₄₋ₐ₎ (II)

where R⁵ is a nonhydrolysable radical and, for each appearance, is identical or different and is a straight-chain alkyl group having 3 to 15 carbon atoms or a branched or cyclic alkyl group having 3 to 15 carbon atoms or an alkenyl or alkynyl group having 2 to 15 carbon atoms, where the aforementioned groups can be substituted with in each case one or more radicals R⁶ and where one or more adjacent or nonadjacent CH₂ groups in the aforementioned groups can be replaced by —R⁶C═CR⁶—, —C≡C—, C═O, C═NR⁶, —C(═O)—O—, —C(═O)—NR⁶—, Si(R⁶)₂, NR⁶, P(═O)(R⁶), —O—, —S—, SO or SO₂, or an aromatic ring system having 6 to 12 aromatic ring atoms which can be substituted in each case with one or more radical(s) R⁶, or a heteroaromatic ring system having 5 to 12 aromatic ring atoms which can be substituted in each case with one or more radical(s) R⁶.

Here, for each occurrence, R⁶ is identical or different and is H, D, F, Cl, Br, I, CHO, CN, C(═O)OH, NO₂, NH₂, OH, NCO, OCN.

X is a hydrolysable group and, for each occurrence, is identical or different and is Cl, Br, I, straight-chain alkoxy group having 1 to 10 carbon atoms or a branched or cyclic alkoxy group having 3 to 10 carbon atoms or an aryloxy group having 6 to 12 carbon atoms.

a is a value between 1 and 4.

Here, at least one R⁶ comprises a functional group to interact with the metal colloids, preferably precisely one R⁶ has a functional group to interact with the metal colloids.

Examples of R⁶ are aminoalkyl or thioalkyl groups. Preferred groups for X are Cl, Br, I, methoxy, ethoxy, n-propoxy, isopropoxy, n-butoxy, tert-butoxy, n-pentoxy, isopentoxy, n-hexoxy, heptoxy, n-octoxy.

Examples of preferred silanes are aminosilanes such as H₂N—(CH₂)₃—Si(OC₂H₅)₃, (C₂H₅)₂N(CH₂)₃Si(OC₂H₅)₃, (CH₃)₂N(CH₂)₃Si(OC₂H₅)₃, H₂N—C₆H₄—Si(OCH₃)₃, (CH₃)₂N—CH₂—CH₂—N(CH₃)—(CH₂)₃—Si(OC₂H₅)₃, H₂N—CH₂—CH₂—NH—(CH₂)₃—Si(OCH₃)₃, H₂N—(CH₂)₂—NH—(CH₂)₂—NH—(CH₂)₃—Si(OCH₃)₃, thiosilanes such as HS—CH₂—Si(OC₂H₅)₃, HS—CH₂—CH₂—Si(OC₂H₅)₃, HS—CH₂—CH₂—CH₂—Si(OC₂H₅)₃, HS—(CH₂)₄—Si(OC₂H₅)₃, HS—CH₂—Si(OCH₃)₃, HS—CH₂—CH₂—Si(OCH₃)₃, HS—CH₂—CH₂—CH₂—Si(OCH₃)₃, HS—(CH₂)₄—Si(OCH₃)₃, HS—(CH₂)₃—Si(CH₃)(OCH₃)₂, or silanes with other functional groups such as NC—(CH₂)₃—Si(OCH₃)₃, HOOC—HC═CH—O—(CH₂)₃—Si(OCH₃)₃, OCN—CH₂—CH₂—CH₂—Si(OC₂H₅)₃, HOOC—CH₂—CH₂—CH₂—Si(OC₂H₅)₃.

In one embodiment of the invention, besides the at least one functional group to interact with the metal colloids, the complexing agent has at least one further functional group with which organic crosslinking is possible, e.g. with a surrounding matrix or a further compound. Examples of such functional groups are epoxide, oxetane, hydroxy, ether, amino, monoalkylamino, dialkylamino, amide, carboxy, mercapto, thioether, vinyl, isocyanate, acryloxy, methacryloxy, acid anhydride, acid halide, cyano, halogen, aldehyde, alkylcarbonyl, sulphonic acid groups. Preferred groups are isocyanate groups, which can also be blocked, epoxide groups, amino groups and anhydride groups. The groups can in particular serve to incorporate the modified metal colloids into polymer compositions. On the one hand via the direct participation in the polymerization reaction of the monomers and/or with the reaction with functional groups on the polymer.

In one embodiment of the invention, the at least one complexing agent is a low molecular weight compound. Preferably, this is a compound with a molecular weight of less than 1000 g/mol, less than 800 g/mol, less than 600 g/mol, less than 500 g/mol, less than 400 g/mol, less than 300 g/mol. Irrespective of this, the complexing agent has a molecular weight of more than 30 g/mol, more than 40 g/mol, more than 50 g/mol.

The complexing agents are not polymers or oligomers, i.e. they have not more than 2 repetitive units.

In one embodiment, the complexing agents are not betaines, with amino acids not being considered to be betaines.

In one embodiment of the invention, the reducing agent is already a complexing agent or a precursor compound thereof. The oxidized form of the reducing agent is particularly preferably a complexing agent. The composition then comprises a reducing agent which is simultaneously the precursor compound for the complexing agent. One example of such a compound is ascorbic acid. This gives rise, as a result of reduction, to dehydroascorbic acid, which is a complexing agent.

In one embodiment of the invention, the composition comprises at least one reducing agent and at least one further complexing agent. Preferably, the further complexing agent is different from the reducing agent or the oxidized form of the reducing agent.

The molar ratio between metal ions and complexing agent is preferably between 30:1 and 1:5, particularly preferably between 30:1 and 1:2. In the event of an excess of complexing agent, the result is a very considerable covering of the surface of the resulting metal colloids. At the same time, the purification of the resulting metal colloids is hindered since a larger amount of unbound complexing agents have to be removed.

In a preferred embodiment of the invention, the molar ratio between metal ions and complexing agent or precursors thereof is between 30:1 and 1:1, preferably between 30:1 and 1.5:1. Despite the deficit of complexing agent, metal colloids are obtained which are protected against agglomeration and immediate oxidation by a layer of complexing agent.

If the reducing agent can also serve as complexing agent or as precursor thereof, the aforementioned ratios are applicable for the sum of any additionally used complexing agents and the corresponding reducing agent (e.g. ascorbic acid as reducing agent and precursor for a complexing agent and cystein as additional complexing agent), taking into consideration the ratios of the electrons stated for the reducing agent.

By using less reducing agent and complexing agent, the purification of the metal colloids is significantly easier than if a compound used in excess has to be separated off.

The composition also further comprises a solvent. This can be water or a different polar solvent. Preferably, the solvent is water. Particularly preferably, the composition comprises only water as solvent.

In a preferred embodiment, the concentration of metal ions in the composition prior to activation is above 0.1 mol/l, more than 0.2 mol/l, more than 0.3 mol/l.

Independently of this, the concentration of the metal ions in the composition is preferably less than 3 mol/l, depending on the solubility.

The concentration of the reducing agent or of the reducing agents is preferably greater than 0.1 mol/l, greater than 0.2 mol/l. Independently of this, the concentration of the reducing agent or of the reducing agents in the composition is below 3 mol/l, preferably below 1 mol/l.

The concentration of the complexing agent or of the complexing agents or the precursors thereof is preferably greater than 0.001 mol/l, greater than 0.005 mol/l. Independently thereof, the concentration of the complexing agent or of the complexing agents in the composition is below 3 mol/l, preferably below 1 mol/l.

The constituents of the composition can be combined in various ways.

In a preferred embodiment, firstly the metal ions and the complexing agent are introduced into the composition. Preferably, the metal ions are first introduced into the solvent and then the complexing agent is added. The addition here preferably takes place slowly, preferably over a period from 5 minutes to 2 hours. Meanwhile, the solution can be thoroughly mixed and/or be already brought to the temperature of the subsequent activation.

The complexing agent can be added without dilution, e.g. as a powder or liquid. In a preferred embodiment, the complexing agent is added in solution or suspension, particularly preferably in solution.

The reducing agent is preferably added as the last component. Preferably, the reducing agent is added slowly, preferably over a period from 5 minutes to 2 hours. The addition can take place without dilution, e.g. as powder or liquid. In a preferred embodiment, the reducing agent is added as solution or suspension, preferably as solution.

If the reducing agent uses a compound which is a precursor for a complexing agent or can itself serve as complexing agent and no further complexing agents are used, the addition of the complexing agent corresponds to the addition of the reducing agent.

The composition preferably comprises no further constituents such as dispersants, catalysts or stabilizers.

The pH of the composition before the reduction is preferably below 7, below 6, below 5, below 4, below 3, below 2. Particularly preferably, it is between 0 and 5, 0 and 3, 1 and 3, 1 and 2.

The process can also be carried out in a certain atmosphere, e.g. argon or nitrogen. Preference is given to implementation in normal air.

During or after the preparation of the composition, a thermal or photochemical activation can take place. This means that the reduction of the metal ions begins.

As photochemical activation, an irradiation with UV light can take place.

A thermal activation is generally a heating of the composition. Depending on the solvent used, these are temperatures between 20° C. and 120° C., preferably between 30° C. and 100° C.

An activation during the preparation of the composition means that during the mixing of the composition a heating and/or irradiation takes place.

The activation results in the reduction of the at least one type of metal ions to metal colloids. The simultaneous presence of the complexing agent prevents an agglomeration of the metal colloids.

It may be necessary to carry out the reduction in a certain temperature range. This may be different depending on the metal ions and reducing agents used. The temperature range can be between 20 and 120° C.

The reaction is preferably carried out while thoroughly mixing the composition in order to prevent an agglomeration of the colloids. This can take place by stirring.

Depending on the metal ions, reducing agents and complexing agents used, it may be necessary to conduct the reaction for a certain time. The time can be between 5 minutes and 48 hours, preferably between 3 hours and 48 hours. Here, the temperature can be increased or lowered. The thorough mixing of the solution can also be continued. Preferably, the solution is held at the same temperature, but stirred somewhat more gently.

The reaction is conducted here without the formation of micelles. The process is also a single-phase process, i.e. at no point is a further liquid phase present, e.g. emulsion. The process preferably includes no further steps, such as the multistage addition of further reducing agents.

In a further step, the modified metal colloids are purified. This means that they are cleaned of compounds not bonded to the metal colloids, such as reducing agent, oxidized reducing agent or complexing agent. The purification can take place here by centrifugation and/or filtration. Preferably, the composition is treated with crossflow filtration. As a result, it is possible to remove complexing agent and reducing agent or their residues not bonded to the metal colloids from the composition. This is possible in particular on account of using low molecular weight compounds as reducing agent and complexing agent. These can be easily separated off in this way without the solvent having to be removed completely.

In this connection, it is important that the conditions for the crossflow filtration are chosen such that the produced metal colloids are not separated off. However, it is possible that only metal colloids of a certain minimum size are retained. In this way, it is possible to control the size distribution of the resulting metal colloids.

The separation can be improved by carrying out the crossflow filtration several times, adding new solvent for each pass. This solvent can also differ from the solvent of the composition. In a preferred embodiment of the invention, the added solvent is the solvent of the composition.

The crossflow filtration here can also be conducted as a continuous process.

If the metal colloids are to be isolated, they can also be centrifuged off and decanted.

The metal colloids obtained are characterized by a particularly high crystallinity. They preferably have a fraction of >80% of crystalline phase (measured with XRD; X-ray diffractometry).

In one embodiment of the invention, the carbon content of the resulting metal colloids is between 1% by weight and 30% by weight (measured with high-temperature combustion).

In a further embodiment of the invention, the metal colloids comprise 0.1% by weight to 5% by weight of N if the complexing agent used has at least one N atom.

In a further embodiment of the invention, the metal colloids comprise 0.1% by weight to 15% by weight of S if the complexing agent used comprises at least one S atom.

In a further embodiment of the invention, the metal colloids obtained are essentially free from metal oxides. Preferably, no signals of metal oxides are to be seen for metal colloids with a fraction of crystalline phase of >80% in the XRD spectrum.

The metal colloids obtained are completely redispersible in different media. These may be nonpolar media, such as hydrocarbons (pentane, hexane, benzene, toluene), polar media such as water, alcohols (methanol, ethanol, propanol, isopropanol, butanol), ethers (diethyl ether, tetrahydrofuran), powder coatings, reactive resins such as polyurethane resins, acrylates, methacrylates, polymers such as thermoplastics, thermoplastic elastomers. Consequently, the metal colloids produced are suitable as additives for many applications.

Depending on the complexing agent used, the long-term stability of the dispersions produced can vary. Preference is given to a stability of more than one day, particularly preferably a stability of more than 5 days. The stability is determined following complete redispersion by visual inspection.

Moreover, the invention relates to a method for the surface modification of metal colloids. For this, in a first step, at least one metal colloid is redispersed in at least one solvent. Preferably, it is a metal colloid which is coated with at least one low molecular weight compound. It is particularly preferably a compound as has been described above as complexing agent.

It is preferably a metal colloid which has been obtained by the process according to the invention. Such metal colloids are coated with at least one low molecular weight compound.

Analogously to the process described above, at least one complexing agent as has also been described for the preparation process is added to the dispersion of the metal colloid.

In a preferred embodiment of the invention, the molar ratio between metal colloids and complexing agents, or precursors thereof, is between 30:1 and 1:1, preferably between 30:1 and 1.5:1. Despite the deficit of complexing agents, metal colloids are obtained which are protected against agglomeration and immediate oxidation by a layer of complexing agent.

Depending on the metal colloid and complexing agent used, it may be necessary to conduct the reaction for a certain time. The time can be between 5 minutes and 48 hours, preferably between 3 hours and 48 hours. Here, the temperature can be increased or lowered. The thorough mixing of the solution can also be continued. The solution is preferably held at the same temperature, but stirring is somewhat more gentle.

It may be necessary to carry out the surface modification in a certain temperature range. This can be different depending on the metal ions and reducing agents used. The temperature range can be between 20 and 120° C.

In the next step, the composition is cleaned from compounds not associated with the metal colloid. These may be complexing agents and/or the prior surface modification of the metal colloids. For the cleaning, preference is given to using crossflow filtration. This process has the advantage that the low molecular weight compounds used can be separated off easily.

It may be necessary to carry out the crossflow filtration several times, adding new solvent with each pass.

The metal colloids obtained preferably have an average diameter (measured with TEM) below 40 nm, below 30 nm, below 20 nm, preferably between 1 nm and 40 nm, between 2 and 30 nm, particularly preferably between 3 and 20 nm, 5 and 20 nm.

The surface-modified metal colloids can be provided easily with very different surface modifications using the described process.

They can therefore be easily incorporated into many environments. These may be monomers or polymers, which can be present in solid or liquid form. They may also be polyethylene, polypropylene, polyacrylate, such as polymethyl methacrylate and polymethyl acrylate, polyvinylbutyral, polycarbonate, polyurethanes, ABS copolymers, polyvinyl chloride, polyethers, epoxide resins, or precursors or monomers of the aforementioned polymers, such as epoxides, isocyanates, methacrylates, acrylates.

In a preferred embodiment, the modified metal colloids are added to the precursors or monomers.

Such compositions can comprise further additives which are added in the art usually according to purpose and desired properties. Specific examples are crosslinking agents, solvents, organic and inorganic coloured pigments, dyes, UV absorbers, lubricants, flow agents, wetting agents, adhesion promoters and starters. The starter can serve for thermally or photochemically induced crosslinking.

The compositions can be processed as liquid. However, they can also be processed to give solids, for example powder coatings. For this, they are mixed with the corresponding precursors, extruded and processed to give powder lacquers, for example based on polyurethane.

If coatings are produced, the coating compositions can be applied to a surface in any customary manner. All customary coating processes can be used here. Examples are centrifugal coating, (electro)dip coating, knife coating, spraying, injecting, spinning, drawing, centrifuging, casting, rolling, painting, flood coating, film casting, knife casting, slot coating, meniscus coating, curtain coating, roller application or customary printing processes, such as screen printing or flexographic printing. The amount of applied coating composition is chosen such that the desired coating thickness is achieved.

After applying the coating composition to a surface or introducing the composition into a mould, a drying optionally takes place, e.g. at ambient temperature (below 40° C.).

The optionally predried coating or the optionally predried moulding is then subjected to a treatment with heat and/or radiation.

In a preferred embodiment, the metal colloids are incorporated into a composition with at least 0.15% by weight, at least 0.3% by weight, at least 0.4% by weight, at least 0.5% by weight, and, independently thereof, with at most 5% by weight, at most 3% by weight.

Particularly for copper-metal colloids, the coatings or mouldings produced therefrom can be equipped with microbicidal properties.

The invention therefore also relates to a moulding or a coating comprising at least one modified metal colloid, preferably in the aforementioned weight fractions. Preference is given to mouldings and coatings made of plastics, particularly preferably polyethylene, polypropylene, polyacrylate, such as polymethyl methacrylate and polymethyl acrylate, polyvinylbutyral, polycarbonate, polyurethanes, ABS copolymers, polyvinyl chloride, polyethers and epoxide resins.

The invention also relates to a substrate, for example made of plastic, metal, glass or ceramic, coated with such a coating.

The modified metal colloids of the invention can be used in many fields.

On account of their composition, the metal colloid particles can be used as additives for establishing electric, photonic, optical as well as in particular also physiologically effective properties.

They can be used for example as additives, pigments or fillers, in coatings, paints, plastics and glassware.

On account of their flexible surface coating, they are also suitable for applications in catalysts.

They can be used in optical or optoelectronic, electric applications, for example for increasing the conductivity of plastics or conductive inks.

They can also be used for spectroscopic purposes.

They can also be used as additives with biocidal properties. As a result of the low molecular weight coating of the metal colloids, biocidally effective copper ions or silver ions can be slowly released, e.g. in the case of copper or silver. Thus, these metal colloids can be used as biocidal active ingredients in compositions. This is also the case if the metal colloids have been incorporated into a matrix.

Moreover, the invention relates to metal colloids which are coated on the surface with at least one low molecular weight compound. Preference is given to metal colloids which have been obtained by the process of the invention.

Further details and features arise from the subsequent description of preferred working examples in conjunction with the dependent claims. In this connection, the respective features can be realized per se by themselves or in multiples or combination with one another. The options for solving the problem are not limited to the working examples. Thus, for example, range data always includes—unspecified—interim values and all conceivable part intervals.

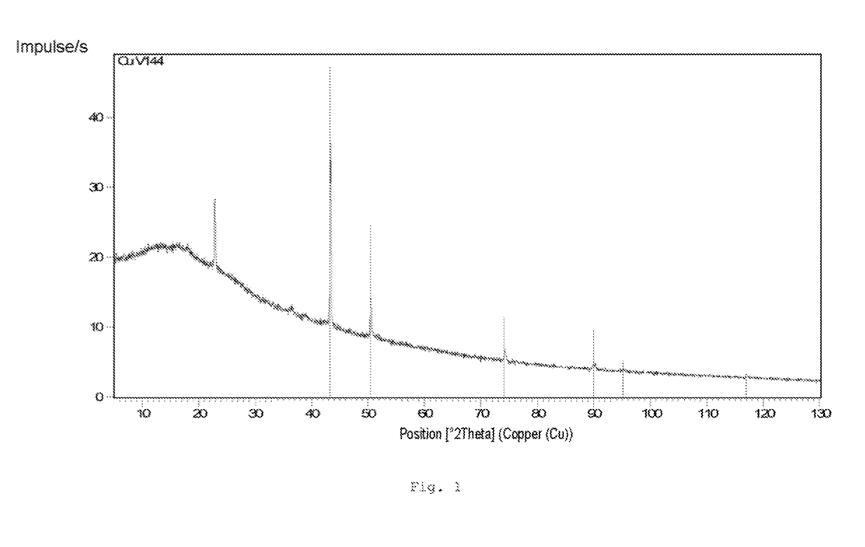

FIG. 1 XRD spectrum of the metal colloids obtained in Example 1 following crossflow filtration (Cu K□);

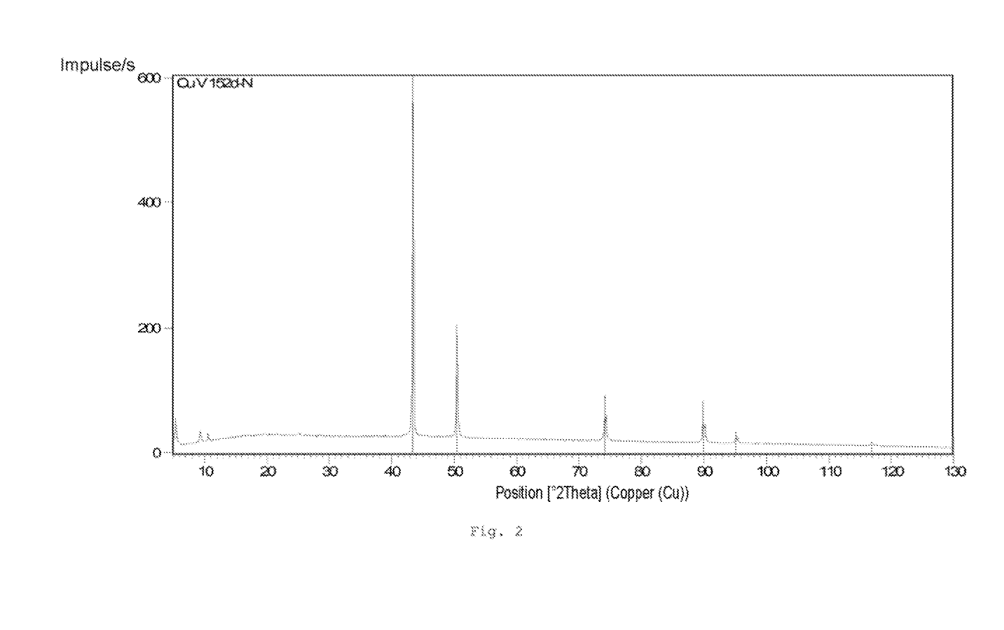

FIG. 2 XRD spectrum of the metal colloids obtained in Example 3 following crossflow filtration;

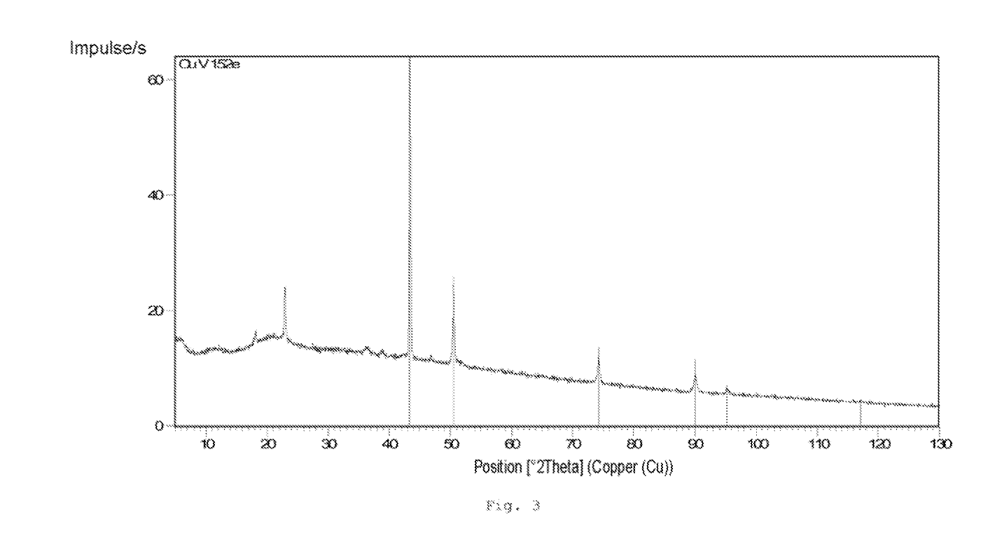

FIG. 3 XRD spectrum of the metal colloids obtained in Example 7 following crossflow filtration;

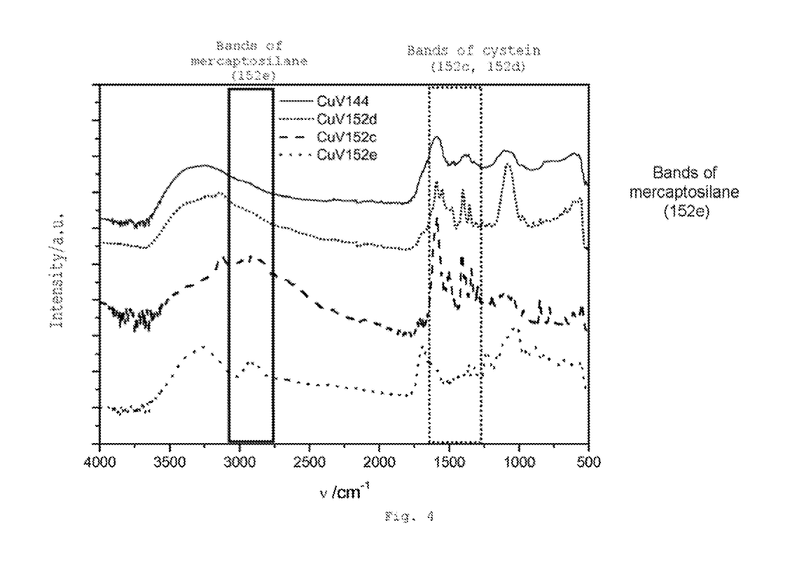

FIG. 4 infrared spectra of different compounds (CuV144, CuV152d, CuV152c, CuV152e);

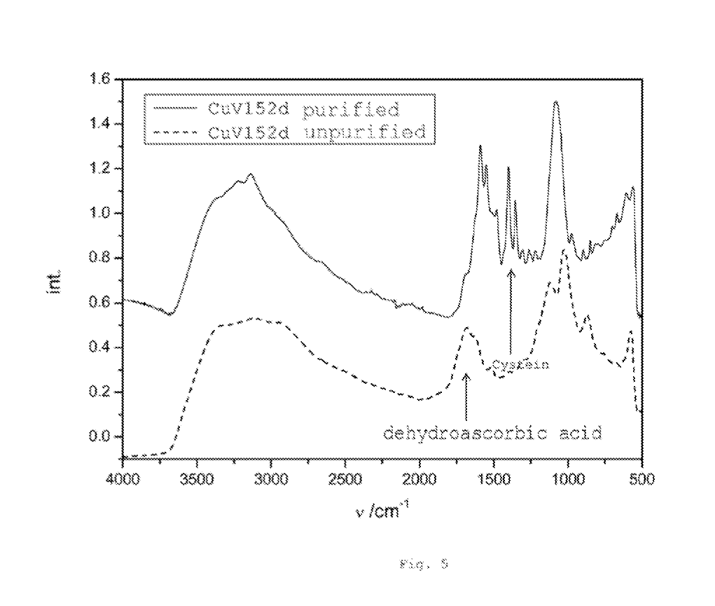

FIG. 5 infrared spectra of a compound (CuV152d) before and after the crossflow filtration;

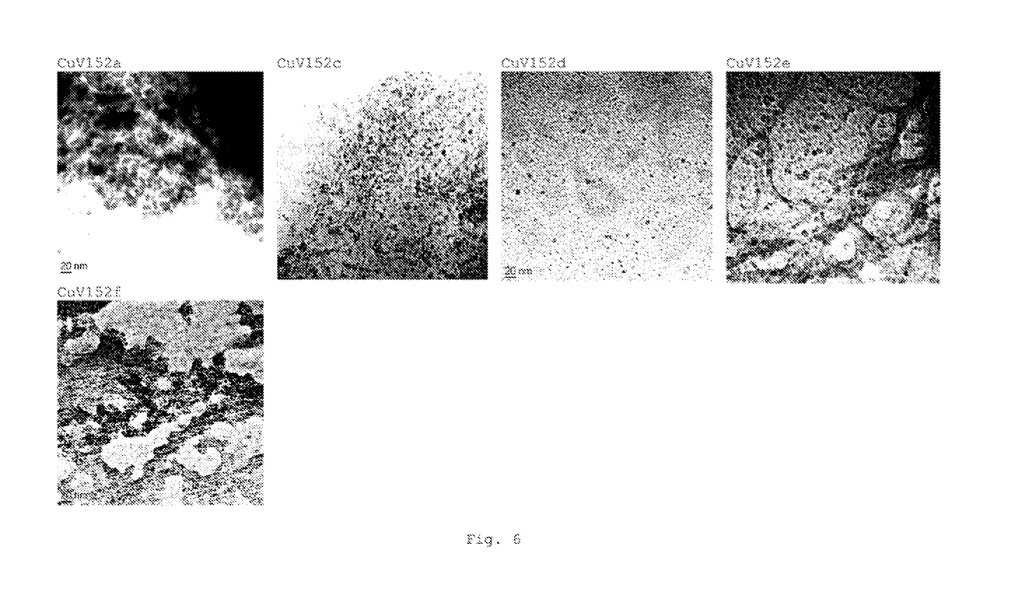

FIG. 6 transmission electron micrographs of dried particle dispersions;

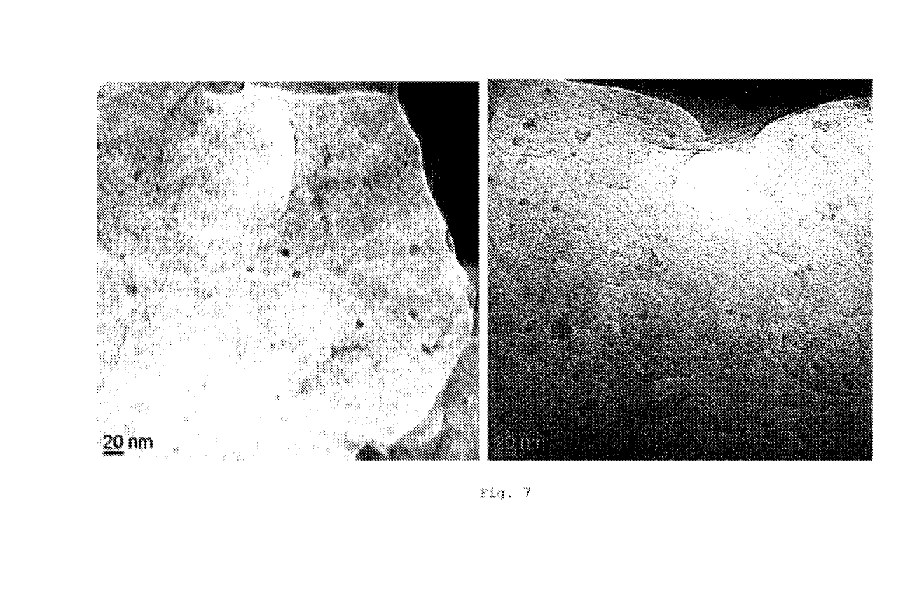

FIG. 7 transmission electron micrographs of Cu colloid particles in epoxide resin Araldite (1% by weight copper, CuV152e in Example 9) left, right CuV152c;

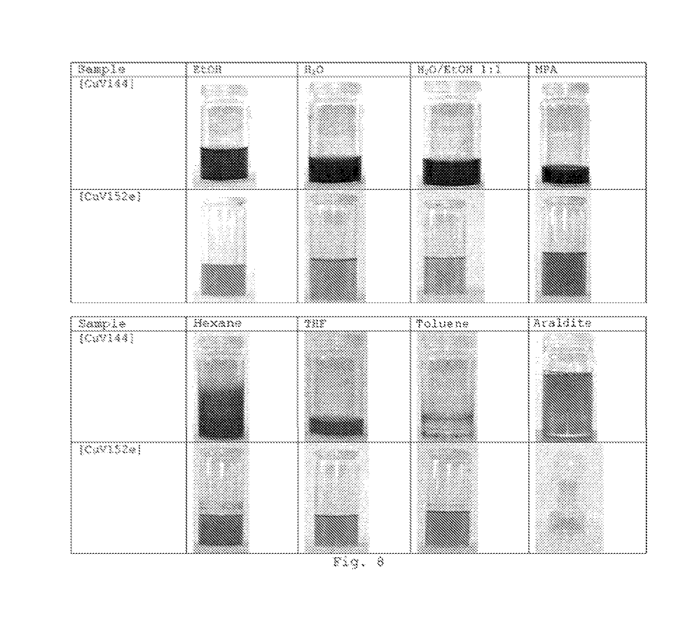

FIG. 8 dispersions of metal colloids in different media after complete dispersion and storage over 4 weeks;

FIGS. 1, 2 and 3 show XRD spectra of the metal colloids obtained. The XRD spectra show pure, crystalline copper with the characteristic reflections, without copper oxides or carbonates. All theoretical Bragg reflections can be observed: the 2θ values are at 43.4°, 50.6°, 74.1°, 90.0° and 95.2°. This corresponds to the Miller indices (111), (200), (220), (311) and (222) of the fcc structure. Following the modification, in addition to the copper reflections, further ones arise at predominantly small 2θ values.

FIG. 4 shows infrared spectra of differently modified copper colloids. All spectra were recorded following crossflow filtration. In the range from 3100 cm⁻¹ to 2750 cm⁻¹ are the bands for the mercaptosilane used in a sample. In the range from about 1700 cm⁻¹ to 1250 cm⁻¹ are the bands of cystein, which were used for two samples. The measurement shows that even after crossflow filtration the surface of the metal colloids is coated with complexing agents.

FIG. 5 shows infrared spectra of a compound CuV152d before and after the crossflow filtration. For the unpurified sample, the bands of dehydroascorbic acid can clearly be seen. Following the purification, the bands of the complexing agent cystein can clearly be seen; this has been successfully attached to the surface of the metal colloid.

FIG. 6 shows transmission electron micrographs (transmission electron microscopy) of dried particle dispersions.

FIG. 8 shows the stability following complete dispersion and storage over 4 weeks. A more precise evaluation of the dispersion process in media with differing polarity and hydrophilicity following visual assessment (++: completely dispersible/stability over 4 weeks, +: completely dispersible/stability over 2 weeks, o: completely dispersible/stability over 1 week, −: completely dispersible, stability over 1 day; MPA: 1-methoxypropyl acetate; Araldite).

Table 2 shows that all of the metal colloids produced are completely dispersible in a broad spectrum in solvents. In this connection, the metal colloids modified with silanes are dispersible in virtually all solvents with excellent stability.

Table 1 shows the result of the elemental analysis for different metal colloids (carbon contents (C-%), nitrogen contents (N-%) and sulphur contents (S-%) in % by weight following purification by means of centrifugation (Z) or crossflow filtration (CF); detection limit: 0.1% by weight).

The elemental analysis (CHNS) was carried out via high-temperature combustion (up to 1200° C.) and gas component separation with a TDP column (temperature programmable desorption; vario Micro Cube, Elementar Analysensysteme GmbH Germany). Calibration of the instrument was carried out using sulphanilamide of different initial weight from the instrument manufacturer (theoretical: 16.26% by weight N; 41.85% by weight C; 4.68% by weight H and 18.62% by weight S). The day factor determination was made directly prior to measurement by measuring 5 times about 2.0 mg of sulphanilamide. As additive, tungsten oxide was added to the samples. The dried powders were measured.

In the case of purification by means of centrifugation, the resulting metal colloid dispersions were centrifuged without crossflow filtration at 12857 rcf (relative centrifugal force) for 10 minutes. The supernatant was poured off or pipetted off. If necessary, solvent was topped up again, the samples were shaken and centrifuged again. This was repeated (generally 3 to 4 times) until foam no longer formed and the supernatant was virtually colourless.

### EXAMPLE 1

### Synthesis with CuSO₄/Dehydroascorbic Acid/Ascorbic Acid [Masterbatch CuV144], Cu:Ascorbic Acid 2:1

75 g (0.3 mol) of CuSO₄.5H₂O were dissolved in 300 ml of water (1M) and introduced into a 1 l round-bottomed flask. At 80° C. and with vigorous stirring (700 rpm), 1M solution of ascorbic acid (26.4 g in 150 ml of water) was slowly added dropwise (5 ml/min). The colour changed from blue to black. The reaction mixture was further stirred at 80° C. for a further 18 h and at a stirring speed of 400 rpm. The reaction mixture was cleaned of the excess ascorbic acid by means of crossflow filtration (column: Midikros 0.2 μm (size cut off), polyethersulphone-PES). The retentate was diluted 1:1 with water and further filtered through the column. This operation was repeated three times. It was then centrifuged and decanted. If desired, the powder was then dried.

### EXAMPLE 2

### Synthesis with CuSO₄/Dehydroascorbic Acid/Ascorbic Acid [Masterbatch CuV153], Cu:Ascorbic Acid 1:2

75 g of CuSO₄.5H₂O were dissolved in 300 ml of water (1M) and introduced into a 1 l round-bottomed flask. At 80° C. and with vigorous stirring (700 rpm), 1M solution of ascorbic acid (105.6 g in 500 ml of water) was slowly added dropwise (10 ml/min). The colour changed from blue to black. The reaction mixture was further stirred at 80° C. for a further 18 h and at a stirring speed of 400 rpm. The reaction mixture was cleaned of the excess ascorbic acid by means of crossflow filtration (column: Midikros 0.2 μm, polyethersulphone-PES). The retentate was diluted 1:1 with water and further filtered through the column. This operation was repeated three times.

### EXAMPLE 3

### Synthesis with CuSO₄/Cystein/Ascorbic Acid Cu:Cystein 20:1—Direct [CuV152d]

25 g (0.1 mol) of CuSO₄.5H₂O were dissolved in 100 ml of water (1M) and introduced into a 250 ml round-bottomed flask. At 80° C. and with vigorous stirring (700 rpm), a solution of 0.6 g (0.005 mol) of cystein in 50 ml of water was added dropwise. A white fine precipitate was formed. Then, 1M solution of ascorbic acid (8.8 g in 50 ml of water) was slowly added dropwise (5 ml/min). The reaction mixture was further stirred at 80° C. for a further 18 h and at a stirring speed of 400 rpm. The brown reaction mixture showed that the reaction is complete. The reaction mixture was cleaned of the excess ascorbic acid by means of crossflow filtration (column: Midikros 0.2 μm, polyethersulphone-PES). The retentate was diluted 1:1 with water and further filtered through the column. This operation was repeated three times.

### EXAMPLE 4

### Synthesis with CuSO₄/Cystein/Ascorbic Acid, Cu:Cystein 10:1—Direct [CuV152a]

25 g of CuSO₄.5H₂O were dissolved in 100 ml of water (1M) and introduced into a 250 ml round-bottomed flask. At 80° C. and with vigorous stirring (800 rpm), a solution of 1.2 g of cystein in 50 ml of water was added dropwise. A white fine precipitate was formed. A 1M solution of ascorbic acid (8.8 g in 50 ml of water) was then slowly added dropwise (5 ml/min). The reaction mixture was further stirred at 80° C. for a further 18 h and at a stirring speed of 400 rpm. The brown reaction mixture showed that the reaction is complete. The reaction mixture was cleaned of the excess ascorbic acid by means of crossflow filtration (column: Midikros 0.2 μm, polyethersulphone-PES). The retentate was diluted 1:1 with water and further filtered through the column. This operation was repeated three times.

### EXAMPLE 5

### Synthesis with CuSO₄/Cystein/Ascorbic Acid, Cu:Cystein 20:1—Indirect [CuV152c]

2.15 g of CuV144 were redispersed in 80 ml of water at 80° C. A brown suspension was formed. A solution of 0.2 g of cystein in 20 ml of water was added dropwise. The reaction mixture was further stirred at 80° C. for a further 18 h and at a stirring speed of 400 rpm. The reaction mixture was cleaned of the excess ascorbic acid and dehydroascorbic acid by means of crossflow filtration (column: Midikros 0.2 μm, polyethersulphone-PES). The retentate was diluted 1:1 with water and further filtered through the column. This operation was repeated three times.

### EXAMPLE 6

### Synthesis with CuSO₄/Cystein/Ascorbic Acid, Cu:Cystein 10:1—Indirect [CuV152f]

2.15 g of CuV144 was redispersed in 80 ml of water at 80° C. A brown suspension was formed. A solution of 0.4 g of cystein in 20 ml of water was added dropwise. The reaction mixture was further stirred at 80° C. for a further 18 h and at a stirring speed of 400 rpm. The reaction mixture was cleaned of the excess ascorbic acid by means of crossflow filtration (column: Midikros 0.2 μm, polyethersulphone-PES). The retentate was diluted 1:1 with water and further filtered through the column. This operation was repeated three times.

### EXAMPLE 7

### Synthesis with CuSO₄/Mercaptosilane/Ascorbic Acid, Cu:Mercaptosilane 20:1—Indirect [CuV152e]

2.15 g of CuV144 was redispersed in 80 ml THF at 60° C. A black suspension was formed. A solution of 0.44 g of 3-mercaptopropyltriethoxysilane in 10 ml of THF was added dropwise. The reaction mixture was further stirred at 60° C. for a further 18 h and at a stirring speed of 400 rpm. The reaction mixture was firstly centrifuged off and taken up with isopropanol. Cleaning was then carried out by means of crossflow filtration (column: Midikros 0.2 μm, polyethersulphone-PES). The retentate was diluted 1:1 with isopropanol and further filtered through the column. This operation was repeated three times.

### EXAMPLE 8

### Synthesis with CuSO₄/Mercaptosilane/Ascorbic Acid, Cu:Mercaptosilane 10:1—Indirect [CuV152g]

2.15 g of CuV144 was redispersed in 80 ml of THF at 60° C. A black suspension was formed. A solution of 1 g of 3-mercaptopropyltriethoxysilane in 15 ml of THF was added dropwise. The reaction mixture was further stirred at 60° C. for a further 18 h and at a stirring speed of 400 rpm. The reaction mixture was firstly centrifuged off and taken up with isopropanol. Cleaning was then carried out by means of crossflow filtration (column: Midikros 0.2 μm, polyethersulphone-PES). The retentate was diluted with isopropanol (1:1) and further filtered through the column. This operation was repeated three times.

### EXAMPLE 9

### 1% by Weight of Cu from CuV152e in UV-Curable Epoxide Resin

0.3 g of CuV152e was stirred into 25 g of Araldite CY 179 CH (cycloaliphatic epoxide resin 7-oxabicyclo[4.1.0]heptane-3-carboxylic acid, 7-oxabicyclo[4.1.0]hept-3-ylmethyl ester, cycloaliphatic epoxide resin 60.00-100.00% by weight); and stirred for a further 16 h at room temperature. 0.1 g of BYK 307 (polyether-modified polydimethylsiloxane) and 2.5 g of 3-ethyl-3-oxetanemethanol was added and the mixture was stirred for a further 30 min. The UV starter UVI 6976 (triarylsulphoniumhexafluoroantimonate salts) was added and the mixture was stirred for 30 min. The resulting mixture was applied to stainless steel by means of a spiral applicator and cured by UV exposure (750 W, 1.5 min) and a subsequent thermal treatment at 140° C. over 30 min. The layer thickness was 22.87±1.53 μm. Furthermore, mouldings with a thickness of 3 mm were produced by means of the same curing method.

### EXAMPLE 10

### 1% by Weight of Cu from CuV152d in Polyurethane Resin

9.4 g of Desmophen 1145 (branched polyester/polyether polyol), 6.3 g of Desmophen 1150 (branched polyester/polyether polyol), 0.4 g of Desmophen 1380 BT (polypropylene ether polyol) and 9.0 g of Desmodur VL (polyisocyanate, diphenylmethane diisocyanate) were stirred together with 0.25 g of CuV152d for 10 min at room temperature. The resulting mixture was applied to stainless steel using a spiral applicator and cured by thermal heating at 140° C. over 30 min. The layer thickness was 35±3 μm.

### EXAMPLE 11

### 1% by Weight of Cu from CuV152a in Acrylate Resin

10 g of trimethylolpropane triacrylate were admixed with 0.01 g of CuV152a, 0.01 g of AIBN (azobisisobutyronitrile) and 0.01 g of Irgacure 184 (1-hydroxycyclohexyl phenyl ketone) and stirred at room temperature. The resulting mixture was applied to stainless steel using a spiral applicator and cured by UV exposure (750 W, 1.5 min) and a subsequent thermal treatment at 130° C. over 30 min. The layer thickness was 28±2 μm.

### EXAMPLE 12

### 1% by Weight of Cu from CuV124 in PU Powder Coating

12 g of the dried sample CuV144 were taken up in THF and the THF was virtually removed to dryness. The residue was mixed with 446 g of Cryolat 2839, 136 g of Crelan EF 403 (cycloaliphatic polyuretdione), 3.0 g of benzoin and 3.0 g of Modaflow III (polyacrylate, ethyl acrylate-2-ethylhexyl acrylate copolymer) and extruded. The resulting particles were ground by means of a jet mill at 3 bar and Sichter (6000 rpm). The coating of steel and aluminium by means of Corona spraying methods was then carried out. The thermal curing was carried out at 200° C. over 20 min. The layer thickness was 125±10 μm. By detaching the aluminium support with HCl conc. moreover, free-standing PU films with a thickness of about 120 μm could be obtained.

### EXAMPLE 13

### Cu from CuV152c in Araldite

0.06 g of CuV152c was stirred into 12.5 g of Araldite CY 179 CH (cycloaliphatic epoxide resin) and the mixture was stirred for a further 16 h at room temperature. 0.03 g of BYK 307 (polyether-modified polydimethylsiloxane) and 1.25 g of 3-ethyl-3-oxetanemethanol were added and the mixture was stirred for a further 30 min. The UV starter UVI 6976 (triarylsulphonium hexafluoroantimonate salts) was added and the mixture was stirred for 30 min. The resulting mixture was applied to stainless steel using a spiral applicator and cured by UV exposure (750 W, 1.5 min) and a subsequent thermal treatment at 140° C. over 30 min. Furthermore, mouldings with a thickness of 3 mm were produced using the same curing method.

TABLE 1

| | Molar ratio | | | |
|---|---|---|---|---|
| System | Cu/prec. | C % (CF) | N % (CF) | S % (CF) |
| [CuV144] | — | 13.88 ± 1.89 | 0.11 ± 0.06 | 0.14 ± 0.08 |
| [CuV153] | — | 20.32 ± 0.51 | <0.1 | <0.1 |
| [CuV152d] | 20/1 | 13.74 ± 1.17 | 1.68 ± 0.24 | 5.97 ± 0.95 |
| [CuV152a] | 10/1 | 10.43 ± 0.13 | 1.94 ± 0.03 | 6.63 ± 0.30 |
| [CuV152c] | 20/1 | 19.10 ± 0.28 | 2.86 ± 0.02 | 8.40 ± 0.17 |
| [CuV152f] | 10/1 | 19.86 ± 0.45 | 3.35 ± 0.11 | 9.28 ± 0.38 |
| [CuV152e] | 20/1 | 9.59 ± 1.34 | 0.14 ± 0.05 | 2.74 ± 0.40 |
| [CuV152g] | 10/1 | 8.56 ± 0.38 | <0.1 | 3.19 ± 0.13 |

TABLE 2

| Medium | [CuV144] | [CuV152d] | [CuV152a] | [CuV152c] | [CuV152f] | [CuV152e] | [CuV152g] |
|---|---|---|---|---|---|---|---|
| EtOH | + | ∘ | + | ∘ | ∘ | ++ | + |
| H₂O | + | + | ∘ | + | ∘ | ++ | + |
| H₂O/EtOH 1:1 | + | ∘ | ∘ | ∘ | + | ++ | + |
| MPA | + | + | ∘ | + | − | ++ | + |
| Hexane | − | − | − | − | − | ∘ | ∘ |
| THF | + | ∘ | ∘ | ∘ | ∘ | ++ | + |
| Toluene | − | − | − | − | − | ++ | + |
| Araldite | − | ∘ | + | + | + | ++ | + |

1. A process for producing metal colloids comprising:
a) production of a composition comprising:
a1) at least one type of metal ion;
a2) at least one organic reducing agent;
a3) at least one complexing agent comprising at least one functional group which can interact with the produced metal colloids, where the reducing agent and/or the oxidized form of the reducing agent can act as a complexing agent; and
a4) at least one solvent;
b) thermal and/or photochemical activation during or after the production of the composition;
c) reduction of the at least one type of metal ions to metal colloids; and
d) purification of the modified metal colloids.

2. The process as claimed in claim 1, wherein the purification of the metal colloids takes place by crossflow filtration.

3. The process as claimed in claim 1, wherein the metal ions are ions of the metals of groups 8 to 16.

4. The process as claimed in claim 1, wherein the metal ions are ions of the metals Cu, Ag, Au, Ni, Pd, Pt, Co, Rh, Ir, Ru, Os, Se, Te, Cd, Bi, In, Ga, As, Ti, V, W, Mo, Sn and/or Zn.

5. The process as claimed in claim 1, wherein the metal ions are introduced as metal salts into the composition.

6. The process as claimed in claim 5, wherein the salts are selected from the group consisting of CuCl, CuCl₂, CuSO₄, Cu(NO₃)₂, AgNO₃, H(AuCl₄), PdCl₂, ZnCl₂, ZnSO₄, Cu(CH₃COO)₂, copper acetylacetonate, CuCO₃, Cu(ClO₄)₂, and Cu(OH)₂.

7. The process as claimed in claim 1, wherein the organic reducing agent is a low molecular weight compound with a molecular weight of less than 1000 g/mol.

8. The process as claimed in claim 1, wherein the organic reducing agent is selected from the group consisting of reductive carboxylic acids, sugars, uronic acids, and aldehydes.

9. The process as claimed in claim 8, wherein the organic reducing agent is a reductive carboxylic acid.

10. The process as claimed in claim 1, wherein the functional group for the interaction with the produced metal colloids is at least one heteroatom selected from the group consisting of N, O, S, F, Cl, Br, and I.

11. The process as claimed in claim 10, wherein the at least one functional group is selected from the group consisting of amino groups, carbonyl groups such as carboxylic acid groups, carboxamide groups, imide groups, carboxylic anhydride groups, carboxylic acid ester groups, aldehyde groups, keto groups, urethanes, carbonyl groups adjacent in 1,2 position or 1,3 position, thiol groups, disulphide groups, hydroxyl groups, sulphonyl groups, and phosphoric acid groups.

12. The process as claimed in claim 1, wherein the at least one complexing agent is a low molecular weight compound with a molecular weight of less than 1000 g/mol.

13. The process as claimed in claim 1, wherein at least one reducing agent is a complexing agent or a precursor compound of a complexing agent.

14. The process as claimed in claim 1, wherein the oxidized form of the reducing agent is a complexing agent.

15. The process as claimed in claim 1, wherein the molar ratio between metal ions and complexing agent is between 30:1 and 1:5.

16. The process as claimed in claim 1, wherein the fraction of the crystalline metallic phase in the formed metal colloids measured with XRD is >80%.

17. The process as claimed in claim 1, wherein the metal ions are copper ions.

18. A process for the surface modification of metal colloids comprising:
dispersion of at least one metal colloid in at least one solvent;
addition of at least one complexing agent comprising at least one functional group which can interact with the at least one metal colloid;
surface modification of the at least one metal colloid; and
purification of the modified metal colloid.

19. The process as claimed in claim 18, wherein metal colloids obtained as claimed in claim 1 are used.

20. A metal colloid coated on the surface with at least one low molecular weight compound.

21. A metal colloid obtained according to the process as claimed in claim 1.

22. A moulding or coating comprising at least one metal colloid as claimed in claim 20.

23. (canceled)

24. The process as claimed in claim 8, wherein the organic reducing agent is citric acid, ascorbic acid, or malic acid.

25. An article comprising a metal colloid as claimed in claim 20, wherein said article comprises an electrical, optical, photonic, or biocidal article.
